(19) United States
(12) Patent Application Publication
(10) Pub. No.: US 2006/0259943 A1
(43) Pub. Date: Nov. 16, 2006

(54) Television broadcast receiver, television broadcast receiving method and television system

(76) Inventor: Takahiro Kimura, Fukaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/407,264

(22) Filed: Apr. 20, 2006

(30) Foreign Application Priority Data
Apr. 22, 2005 (JP) 2005-125492

(51) Int. Cl. H04N 7/16; H04N 7/173; G06F 13/00; H04N 5/445

(52) U.S. Cl. 725/134; 725/142; 725/58

(57) ABSTRACT

A television broadcast receiver can treat the external recording equipment with same feeling as that of internal recording equipment, even if the external recording equipment is additionally provided. For that, the broadcast receiver includes a control unit to manage operations, a receiving unit to receive a broadcast signal, a demodulator and signal processor to demodulating and signal processing unit to convert the received signal into a display signal, a recording processor, and internal recording equipment. The broadcast receiver further includes a connection terminal to connect external recording equipment and an equipment management unit to register and manage the external recording equipment as expansion equipment for a capacity of the internal recording equipment.

### CROSS-REFERENCE TO RELATED APPLICATIONS

This application is based upon and claims the benefit of priority from Japanese Patent Application No. 2005-125492, filed Apr. 22, 2005, the entire contents of which are incorporated herein by reference.

### BACKGROUND

1. Field

One embodiment of the present invention relates to a television broadcast receiver, a television broadcast receiving method and a television system. More specifically, the embodiment of the invention relates to improvement in an extension function of a recording device.

2. Description of the Related Art

In recent years, an information recording media such as hard disks and an optical disks as recording media have been increased in storage capacity. Therefore, a method and an apparatus for automatically recording a desired program on a recording medium by connecting a recording/reproducing device using such an information recording medium to, for example, a television receiver have been available.

In general, program recording reservation information is prepared by using electronic program guide (EPG) information so as to realize an automatic recording function and an automatic recording/reproducing apparatus. It has been taken into consideration for equipment to automatically set the recording reservation information by automatically retrieving a program which seems to be relevant to a category depending on the EPG information when a desired category is specified. Such equipment is configured to receive a broadcast program and record it on an internal hard disk device (HDD), based on the recording reservation information.

However, in the case of the use of the foregoing recording equipment for a long period, the remaining capacity of the HDD becomes small, so that a user must delete a program which has already been recorded. As measures to solve such a defect, an apparatus to continuously record programs has been developed, when it is impossible for an internal HDD to record program information, wherein the device is connected to a plurality of sets of external recording equipment in advance (refer to, for example, a patent document of Japanese patent application KOKAI publication No. 2003-272297).

However, in the above-mentioned conventional apparatus, it is impossible for a user to treat external recording equipment as heretofore like interval recording equipment sometimes even when the user records the program information through the external recording equipment. For example, if the external recording equipment is one for a digital-video home system (D-VHS), revolving reproduction becomes impossible. Therefore, the user loses a conventional feeling of use.

### BRIEF SUMMARY OF THE INVENTION

According to one embodiment of this invention, it is to provide a television broadcast receiver, a television broadcast receiving method and a television system allowing a user to treat external recording equipment with a similar feeling of use in internal recording equipment even when the external recording equipment is additionally provided to the broadcast receiver and the like.

In order to attain the above object, in the embodiment of the invention, a television broadcast receiver comprises a control unit to manage operations; a receiving unit to receive a broadcast signal, based on the control by the control unit; a demodulating and signal processing unit to demodulate and signal-process the received signal to covert it into a video signal; and a recording processor to record the video signal on a recording medium in accordance with an operation input. Wherein, the broadcast receiver further comprises first recording equipment integrated therewith; a connection terminal to connect external second recording equipment; and an additionally provided equipment registration unit to register the second recording equipment as expansion equipment of a capacity of the first recording equipment.

According to the above-described configuration, even when the user starts to use the external second recording equipment, the user can obtain a function similar to the case that the user uses the built-in first recording equipment as heretofore and does not lose the conventional feeling of use.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view for schematically explaining a digital television broadcast receiver regarding one embodiment of the invention adopted thereto;

FIG. 2 is an exemplary view showing an external view of the broadcast receiver in FIG. 1;

FIG. 3 is an exemplary view for further specifically showing a configuration of an inside of the broadcast receiver in FIG. 1;

FIG. 4 is an exemplary view for schematically explaining a remote controller used in the broadcast receiver regarding the embodiment;

FIG. 5 is an exemplary flowchart when the broadcast receiver in FIG. 1 records a program on the basis of EPG information;

FIG. 6 is an exemplary view showing an example when the broadcast receiver in FIG. 1 displays program information on a video display;

FIG. 7 is an exemplary flowchart of operations in the case that the program is reproduced from digital recording equipment by the broadcast receiver in the embodiment of the invention in FIG. 1;

FIG. 8 is an exemplary view for explaining an example of a navigation menu displayed in reproduction operations of the broadcast receiver in the embodiment in FIG. 1;

FIG. 9 is an exemplary view for explaining a state in which an item of a recorded program is selected from a navigation menu regarding the embodiment in FIG. 1;

FIG. 10 is an exemplary view for explaining an example of a list display screen of recently recorded programs obtained from the navigation menu regarding the embodiment in FIG. 1;

FIG. 11 is an exemplary view showing an example of a configuration of a characteristic part in the embodiment of the invention;

FIG. 12 is an exemplary flowchart for explaining an example of operations of the characteristic part in the embodiment of the invention;

FIG. 13 is an exemplary view showing an example of a screen immediately after the registration of additionally provided equipment in the embodiment of the invention;

FIG. 14 is an example view showing an another example of screen immediately after the registration of the additionally provided equipment in the embodiment of the invention; and

FIG. 15 is an example view showing an example of a screen showing an aspect of utilization of the additionally provided equipment in the embodiment of the invention.

### DETAILED DESCRIPTION

Hereinafter, embodiments of the present invention will be explained by referring to the drawings. At first, we will schematically explain a broadcast receiver with the present invention adopted thereto.

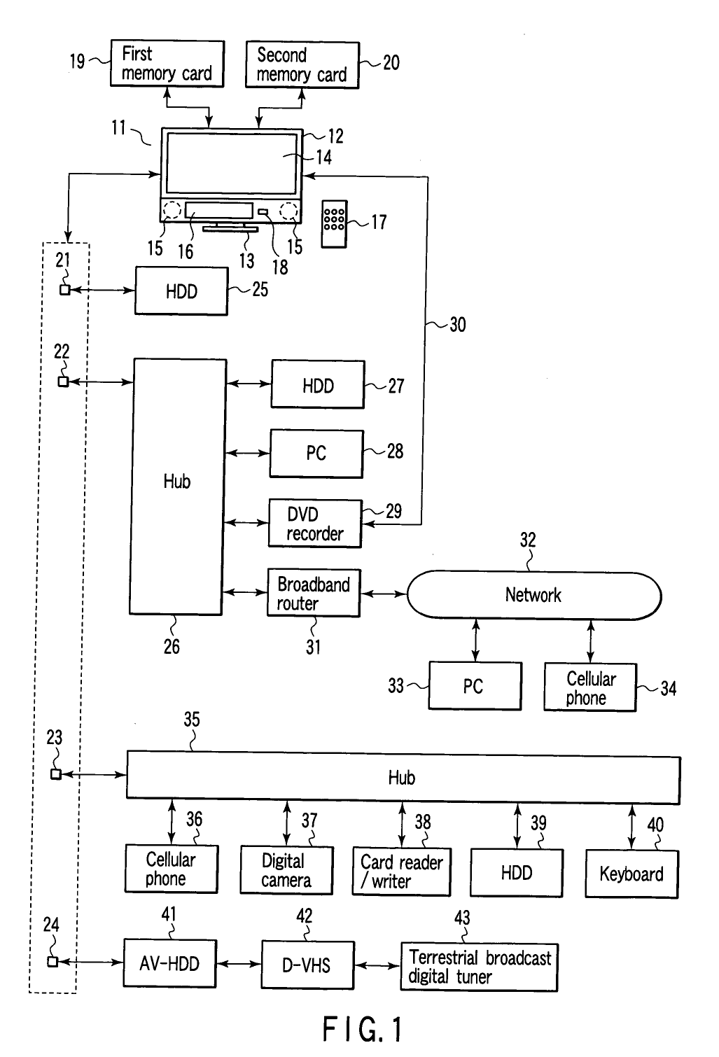

FIG. 1 schematically shows an external appearance of a digital television broadcast receiver 11 to be explained in the embodiments and an example of a network system configured around the broadcast receiver 11.

The broadcast receiver 11 is composed mainly of a thin cabinet 12 and a support base 13 making the cabinet 12 raised and supported. The cabinet 12 is provided with a flat panel type video display unit 14 composed of a liquid crystal display panel or the like, a loudspeaker 15, an operation unit 16, and a light receiving unit 18 to receive operation information transmitted from a remote controller 17.

The broadcast receiver 11 is adapted to receive a first detachable memory card 19 such as a Secure Digital (SD) memory card (trademark), a Multimedia Card (MMC) (trademark) or a Memory Stick (trademark), and performs recording/reproducing of information about such as a program or a photograph to and from the first memory card 19.

The broadcast receiver 11 is further adapted to receive a second detachable memory card (IC card) 20 with, for example, contract information recorded thereon and performs recording/reproducing of information to and from the second memory card 20.

The broadcast receiver 11 is provided with a first local area network (LAN) terminal 21, a second LAN terminal 22, a universal serial bus (USB) terminal 23 and an i.Link (trademark) terminal 24.

Among these parts, the first LAN terminal 21 is used as a LAN-compatible HDD dedicated port. The first LAN terminal 21 is connected to a LAN-compatible HDD 25 being network attached storage (NAS). The first LAN terminal 21 is used to record/reproduce information to and from through a network (e.g., Ethernet network).

As mentioned above, by providing the first LAN terminal 21 to be the LAN-compatible HDD dedicated port, the broadcast receiver 11 can stably record a program with a high image quality to the HDD 25 without being influenced by other network environment or the status of use of the network.

The second LAN terminal 22 is used as a general LAN-compatible port using Ethernet. The second LAN terminal 22 is connected to equipment, for example, a LAN-compatible HDD port 27, a personal computer (PC) 28, and a digital versatile disk (DVD) recorder 29 with a built-in HDD through a hub 26 and used to communicate information between the equipment and the broadcast receiver 11.

Since digital information communicated through the second LAN terminal 22 is control information, the DVD recorder 29 utilizes a dedicated analog transmission path 30 to transmit analog information of video and sound to the broadcast receiver 11.

The second LAN terminal 22 is connected to, for example, a network 32 such as the Internet via a broadband router 31 connected to the hub 26 and used to communicate information between a PC 33, a cellular phone 34 or the like, and the broadcast receiver 11 via the network 32.

The USB terminal 23 is used as a general USB-compatible port, connected to, for example, a cellular phone 36, a digital camera 37, a card reader/writer 38 for a memory card, an HDD 39, or a keyboard 40. The USB terminal is used to make information transmissions between the equipment and the broadcast receiver 11.

The foregoing i.Link terminal 24 serially connects an AV-HDD 41, a Digital (D)-Video Home System (VHS) 42, etc. and supports information-transmissions between the equipment and the broadcast receiver 11.

Here, the AV-HDD 41 connected to the i.Link terminal 24 is shown outside the broadcast receiver 11 in FIG. 1; however, it is actually incorporated in the support base 13. That is, the AV-HDD 41 is integrated with the broadcast receiver 11.

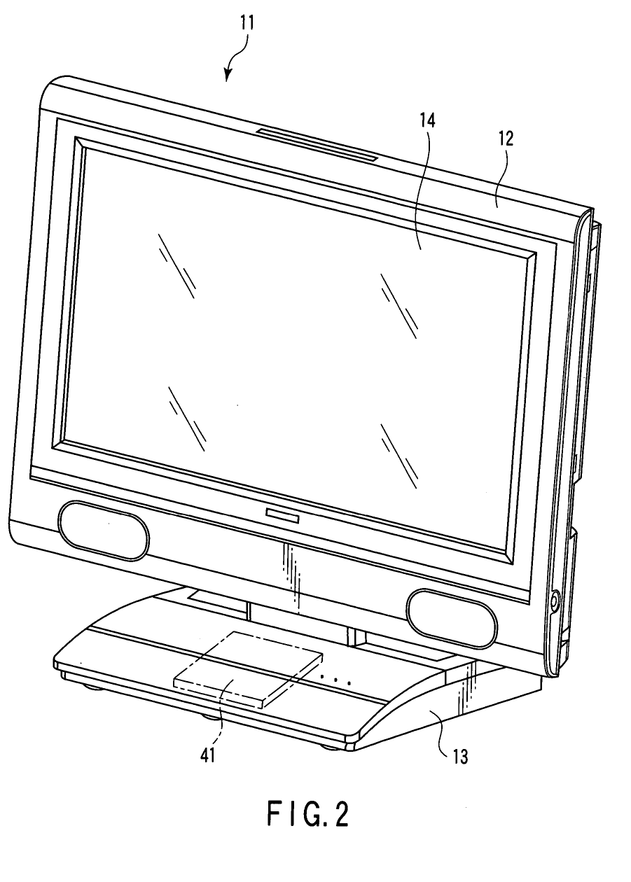

FIG. 2 shows the external appearance of the aforementioned broadcast receiver 11. The AV-HDD 41 (built-in recording equipment) is incorporated in the support bas 13.

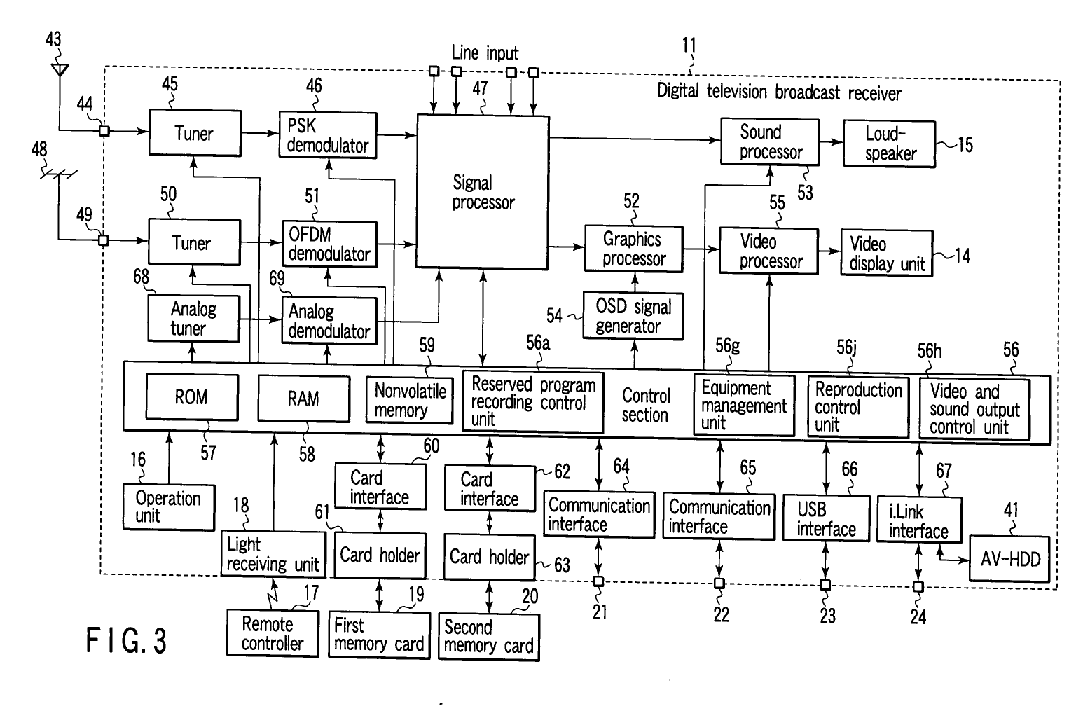

FIG. 3 shows the principle signal processing series of the foregoing broadcast receiver 11. That is, a satellite digital television broadcast signal, received at an antenna 43 for receiving DBS digital broadcasts, is supplied to a tuner 45 for satellite digital broadcasts through an input terminal 44, and the tuner 45 tunes a broadcast signal of a desired channel.

The broadcast signal tuned by the tuner 45 is supplied to a phase shift keying (PSK) demodulator 46 to be demodulated to a digital video signal and a digital sound signal, which are output to a signal processor 47.

And the broadcast receiver 11 also has an analog tuner 68 for receiving a terrestrial analog signal. An analog demodulator 69 demodulates the signal received by the analog tuner 68 to output it to the signal processor 47.

A terrestrial digital television broadcast signal, received at a second antenna 48 for receiving terrestrial digital broadcast, is supplied to a tuner 50 for the terrestrial digital television broadcast via an input terminal 49. The tuner 50 tunes the broadcast signal of the desired channel.

The broadcast signal tuned by the tuner 50 is supplied to an orthogonal frequency division multiplexing (OFDM) demodulator 51 to be demodulated to a digital video signal and a digital sound signal then output to the signal processor 47.

The signal processor 47 selectively conducts prescribed digital signal processing to the digital video signals and sound signals supplied from the PSK demodulator 46 and further from the OFDM demodulator 51, and also to the video signals and sound signals supplied from the analog demodulator 69 and further from the line input terminals, and then outputs the processed signals to a graphics processor 52 and a sound processor 53.

Among the processors, the graphics processor 52 has a function to superimpose an on-screen display (OSD) signal generated from an OSD signal generator 54 onto the digital video signal supplied from the signal processor 47 to output the superimposed signal. The graphics processor 52 can selectively output the video signal output from the signal processor 47 and the OSD signal output from the OSD signal generator 54 and also combine to output both outputs so that each of both outputs configures a half of a screen, respectively.

The digital video signal output from the graphics processor 52 is supplied to a video processor 55. The video processor 55 converts the input digital video signal into an analog video signal in a format possible to be displayed on the video display unit 14 and outputs the analog video signal to the video display unit 14 to produce a video display.

The sound processor 53 converts the input digital sound signal into an analog sound signal in a format that can be reproduced by the loudspeaker 15 and outputs the analog sound signal to the loudspeaker 15 to reproduce sound.

As further shown in FIG. 2, the broadcast receiver 11 further comprises a control unit 56 to integrally control the whole operations including the foregoing various receiving operations.

The control unit 56 has a built-in central processing unit (CPU), which receives operation information from the operation unit 16, or receives operation information transmitted from the remote controller 17 and respectively controls each part so as to reflect operation contents thereto.

In this case, the control unit 56 mainly uses a read only memory (ROM) 57 with a control program to be executed by the CPU stored thereon, a random access memory (RAM) 58 to provide an operation area to the CPU and a nonvolatile memory 59 to which a variety of items of setting information and control information are stored.

The control unit 56 is connected to a card holder 61 to which the first memory card 19 can be attached through a card interface 60. Thereby, the control unit 56 is adapted to support the exchange of information transmissions with the first memory card 19 attached to the card holder 61 through the card interface 60.

The control unit 56 is further connected to a card holder 63 to which the second memory card 20 can be attached through a card interface 62. The control unit 56 thereby can communicate information with the second memory card 20 attached to the card holder 63 through the card interface 62.

The control unit 56 is also connected to the first LAN terminal 21 through a communication interface 64. The control unit 56 thereby can communicate with the LAN-compatible HDD 25 connected to the first LAN terminal 21 through the communication interface 64. In this case, the control unit 56 has a dynamic host configuration protocol (DHCP) server function and assigns an Internet Protocol (IP) address to the LAN-compatible HDD 25 connected to the first LAN terminal 21 to control the HDD 25.

The control unit 56 is further connected to the second LAN terminal 22 through a communication interface 65. The control unit 56 thereby can communicate with any equipment (refer to FIG. 1) connected to the second LAN terminal 22 through the communication interface 65.

The control unit 56 is further connected to the USB terminal 23 through a USB interface 66. The control unit 56 thereby can communicate with any equipment (refer to FIG. 1) connected to the USB terminal 23 through the USB interface 66.

Furthermore, the control unit 56 is connected to the i.Link (registered trademark) terminal 24 through an i.Link (registered trademark) interface 67. Thereby, the control unit 56 can communicate with any equipment (refer to FIG. 1) connected to the i.Link (registered trademark) terminal 24 through the i.Link (registered trademark) interface 67.

The control unit 56 furthermore includes a reserved program recording control unit 56a to reserve a recording program in advance to record it on a recording medium and an equipment management unit 56g. The control unit 56 also includes a reproduction control unit 56j to control a reproduction operation of the recording equipment.

The equipment management unit 56g as described later, includes an additionally provided equipment registration unit 56g2 and structures a featured part of the broadcast receiver 11. We will further describe about the featured part later.

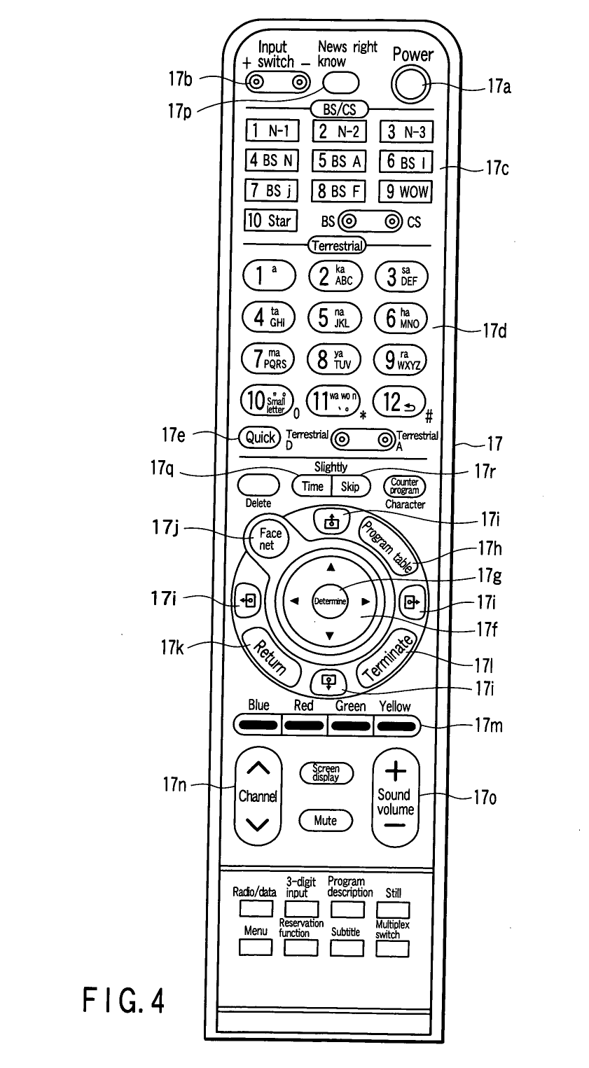

FIG. 4 shows the external appearance of the remote controller 17. The remote controller 17 mainly comprises a power key 17a, input switching keys 17b, direct tuning keys 17c for satellite digital broadcast channels, direct tuning keys 17d for terrestrial broadcast channels, a quick key 17e, a cursor key 17f, a determination key 17g, a program table key 17h, page switching keys 17i, a Face Net (registered trademark) (navigation) key 17j, a return key 17k, a terminate key 17l, color keys in blue, red, green and yellow 17m, a channel up and down key 17n, a sound volume adjusting key 17o, etc. Furthermore, the remote controller 17 has a “News right now” key 17p, a “Slightly time” key 17q and a “Slightly skip” key 17r.

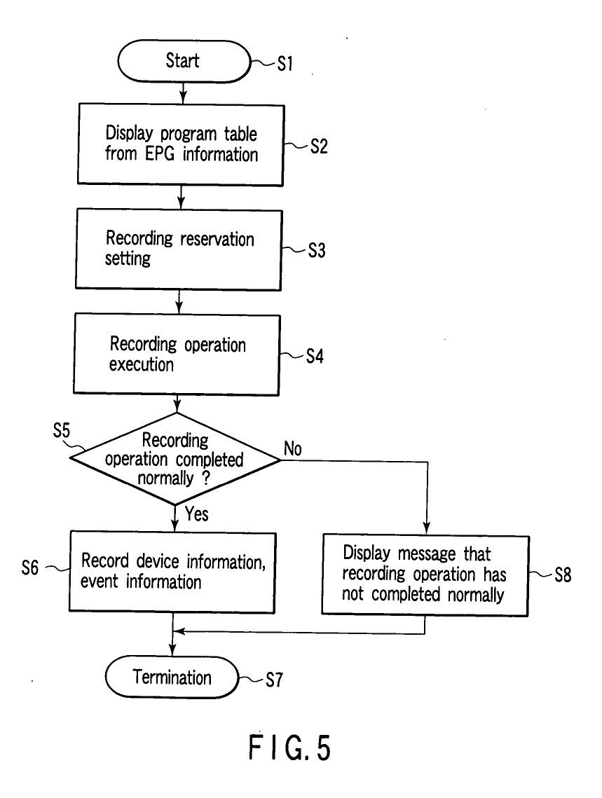

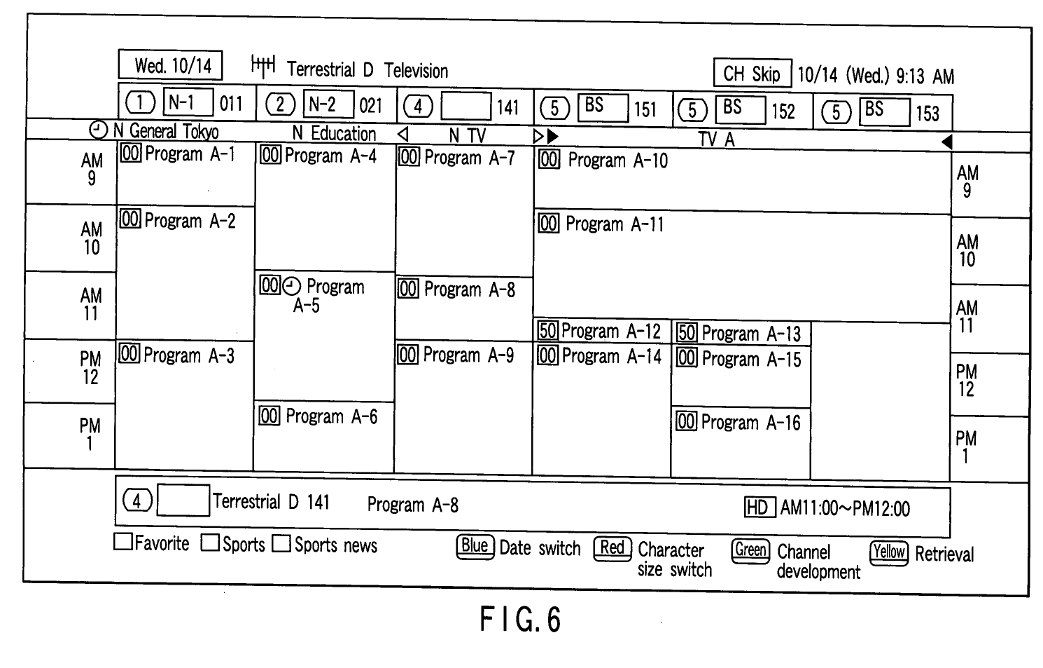

FIG. 5 shows the flowchart for explaining the operations of the broadcast receiver 11 in recording a program into the digital recording equipment among each of the equipment connected to the terminals 21-24 of the broadcast receiver 11. That is, when processing is started resulting form a request of the recording of the program (block S1), the control unit 56 in FIG. 3 displays the program table as shown in FIG. 6 on the video display unit 14 on the basis of electronic program guide (EPG) information acquired from the broadcast signal (block S2).

The user then makes recording reservation setting of the desired programs on the basis of the displayed program table (block S3). In this setting, the broadcast receiver 11 selects the programs to be recorded from the program table and also selects to set the digital recording equipment to which the reservation-set program is recorded.

The control unit 56 executes a recording operation so as to record the reservation-set program into the reservation-set digital recording equipment when it has reached the preset time set for the recording reservation (block S4).

The control unit 56 then determines whether or not the program recording operation has normally completed (block S5), and if it is determined that the recording operation has completed normally (YES, in block S5), the broadcast receiver 11 records equipment information (equipment ID, equipment name, shared holder name, etc.) to specify the digital recording equipment which has performed recording. The broadcast receiver 11 further records event information (event ID, channel number, title, content description, category, recording range, image quality mode, etc.) related to the recorded program into the nonvolatile memory 59 (block S6) and terminates this processing (block S7).

If it is determined that the operation has not completed normally (NO, in block S5), the control unit 56 in FIG. 3 displays a message indicating the fact that the operation has not completed normally onto the video display unit 14 in FIG. 1 (block S8) and terminates this processing (block S7).

According to the above-mentioned recording operations, the user can arbitrarily select multiple sets of digital recording equipment connected to each terminal 21-24 of the broadcast receiver 11 and record programs sequentially.

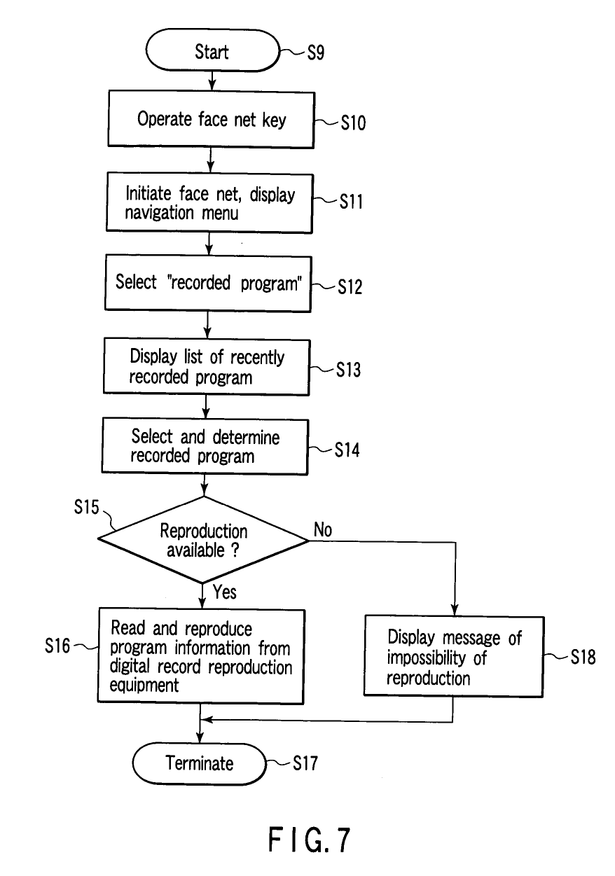

FIG. 7 shows the flowchart for explaining operations to quickly retrieve the desired program and reproduce among a variety of programs recorded in the plurality of sets of the digital recording equipment as mentioned above. When the processing begins (block S9), the user operates the Face Net (registered trademark) key 17j of the remote controller 17 (block S10). (Note: Face Net (registered trademark) is a graphical guide screen for the user.)

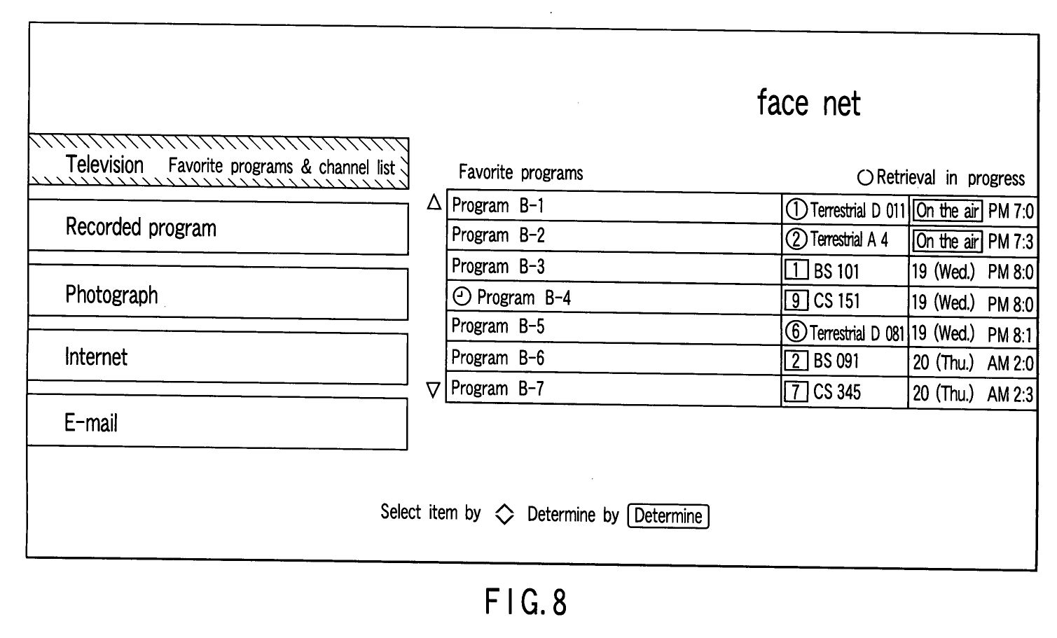

The control unit 56 then starts up the Face Net (registered trademark) (navigation) and displays the navigation menu as shown in FIG. 8 onto the video display unit 14 (block S11). Five items of “television”, “recording program”, “photograph”, “Internet” and “e-mail” are selectively provided in this menu. The selected items are displayed on a screen in different color from those of other items, and a state in which the “television” item is selected is indicated by hatching in FIG. 8.

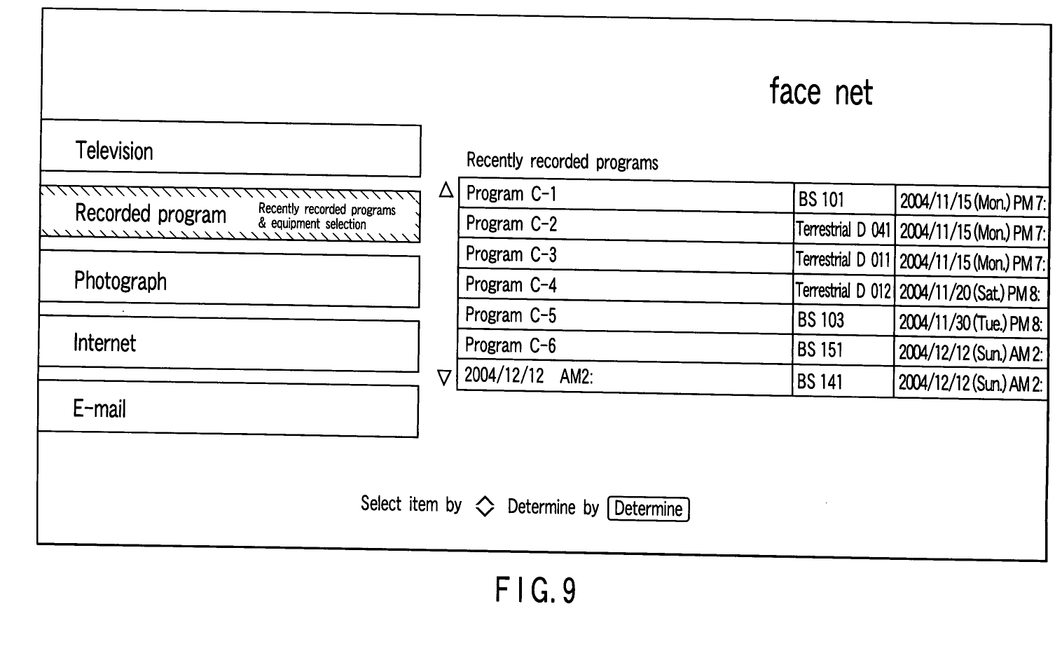

Here, it is assumed that the use operates the cursor key 17f of the remote controller 17 and selects the “recording program” item (block S12). The control unit 56 is brought into a state of selection of the “recording program” item as indicated by hatching in FIG. 9.

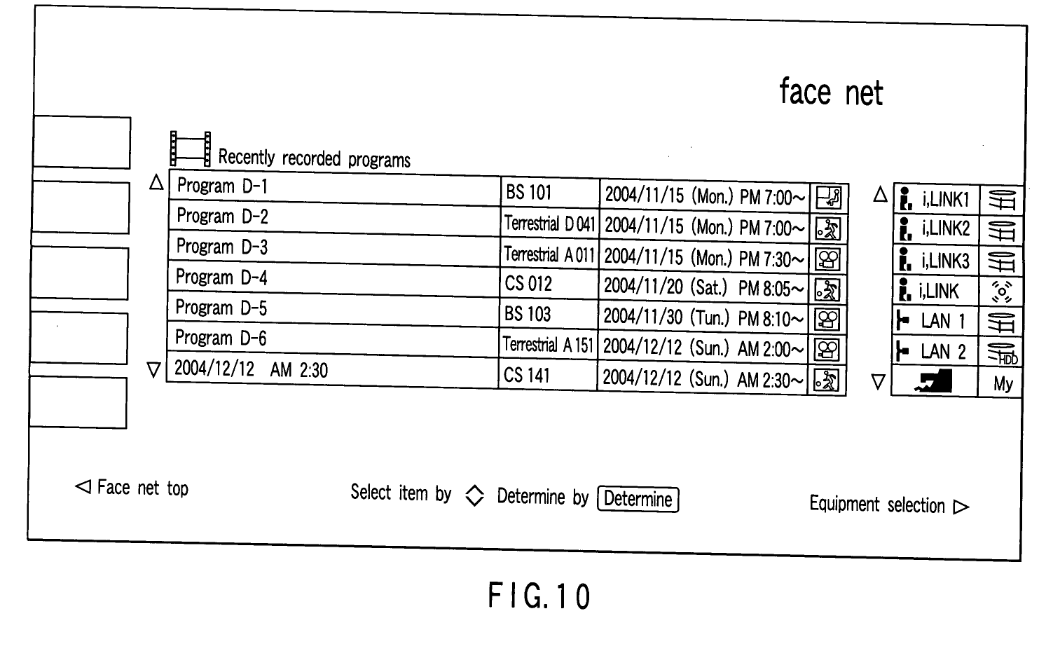

In this state, when the user operates the determine key 17g of the remote controller 17, the control unit 56 displays a list of the recently recorded programs onto the video display unit 14 as shown in FIG. 10 (block S13). In this program list, the titles, broadcast channels, recording dates, days of the week, recording hours, categories, etc., are displayed as information indicating the recorded programs.

The list of the recently recorded programs is created by referring to equipment information specifying the digital recording equipment that has conducted the recording and the event information in relation to the recorded programs recorded on the nonvolatile memory 59 in reservation recording of the programs explained in FIG. 5. In the list, it is possible to display information indicating thirty-five programs at a maximum as far back as from the latest recorded program in relation to the list of recently recorded programs, regardless of the digital recording equipment with the program recorded therein. Having displayed seven programs in a list form in FIG. 10, the user can see the list of thirty-five programs by operating the cursor key 17f to scroll the display. If operating the page switching key 17i of the remote controller 17, the user can skip at once the seven programs displayed in the list.

When the user operates the cursor key 17f of the remote controller 17 to select information indicating the desired program from the list of the recently recorded programs and operates the determination key 17g to determine the desired program (block S14), the control unit 56 specifies the digital recording equipment with the selected and determined program recorded therein from information recorded in the nonvolatile memory 59 and determines whether or not the program can be reproduced (block S15).

Whether the program can be reproduced or not is determined by comprehensively comparing various conditions in recording and in reproducing. For example, this may be conducted by determining one or more of the following: (i) whether or not the broadcast receiver 11 is connected to the digital recording equipment with the reproduction-requested program recorded therein, (ii) whether or not power is turned on to the digital recording equipment with the reproduction-requested program recorded therein, (iii) whether or not the program is still recorded in the targeted digital recording equipment, etc.

Referring still to FIG. 7, if it is determined that the recorded program can be reproduced (YES, in block S15), the control unit 56 reads out the information about the reproduction-requested program from the targeted digital recording equipment and controls the broadcast receiver 11 to reproduce the program (block S16) then terminates this processing (block S17).

If it is determined that the recorded program cannot be reproduced (NO, in block S15), the control unit 56 displays a message indicating the fact that the reproduction-requested program cannot be reproduced on the video display unit 14 and terminates this processing (block S17).

According to the aforementioned reproduction operations, since the broadcast receiver 11 has a navigation function to display, in a list, the thirty-five recorded programs at a maximum as far back as from the latest recorded program regardless of the digital recording equipment with the desired program recorded therein, the user can easily manage the programs recorded in a plurality of sets of digital recording equipment. Consequently, it becomes possible for the user to quickly retrieve and reproduce the desired program by locating the desired program through use of the cursor key 17f and selecting the desired program among programs displayed in a list form through use of the determination key 17g.

Considering the increase in the number of the connected sets of the digital recording equipment and the recorded programs, it becomes impractical to display in a list the whole of the programs recorded in the plurality of sets of the digital recording equipment. As the embodiment stated above, it is a practical setting to hardly cause substantial trouble for the user to display, in a list form, a predetermined number of programs (e.g., thirty-five programs) at a maximum as far back as from the newest recorded program.

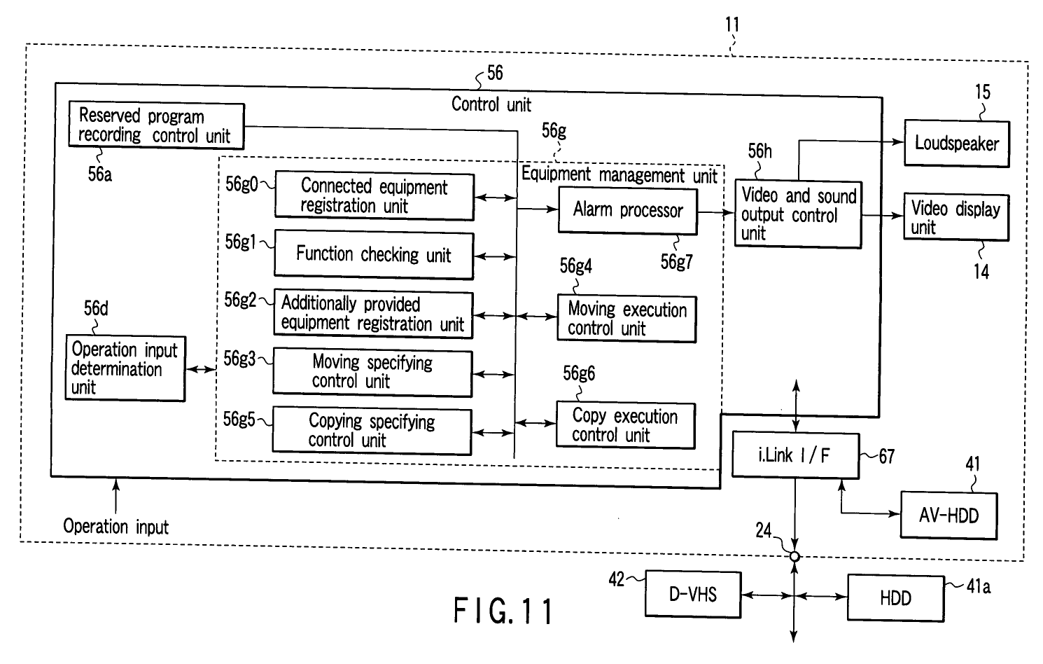

FIG. 11 is an exemplary view for showing the details of the control unit 56 to explain characteristics of the broadcast receiver 11.

An equipment management unit 56g has a connected equipment registration unit 56g0 and a function checking unit 56g1 to check the function of the connected equipment. The equipment management unit 56g may further have an additionally provided equipment registration unit 56g2. The additionally provided equipment registration unit 56g2 is different from the forgoing connected equipment registration unit 56g0 in registration conditions. The connected equipment registration unit 56g0 registers all of the equipment connected to the broadcast receiver 11. On the other hand, the additionally provided equipment registration unit 56g2 registers external recording equipment (HDD 41) having the same function that of the internal AV-HDD 41. Therefore, the external recording equipment 41a is intentionally checked in its function by means of software initiated by an operation of the user, and when the prescribed condition is satisfied, the ID, etc., of the external recording equipment 41a are registered in the registration unit 56g2.

Furthermore, the equipment management unit 56g has a moving specifying control unit 56g3 to select a content recorded in the first recording equipment and specify the moving to the second recording equipment and a moving execution control unit 56g4 to execute the moving. Moreover, the equipment management unit 56g has a copy specifying control unit 56g5 and a copy execution control unit 56g6 for specifying recording equipment regarding an origin of a copy and a content to be copied and also specifying recording equipment to be a destination of the copy. The equipment management unit 56g also includes an operation input determining unit 56d. The determining unit 56d analyzes the command for the operation inputs and contributes for operation starts of any unit.

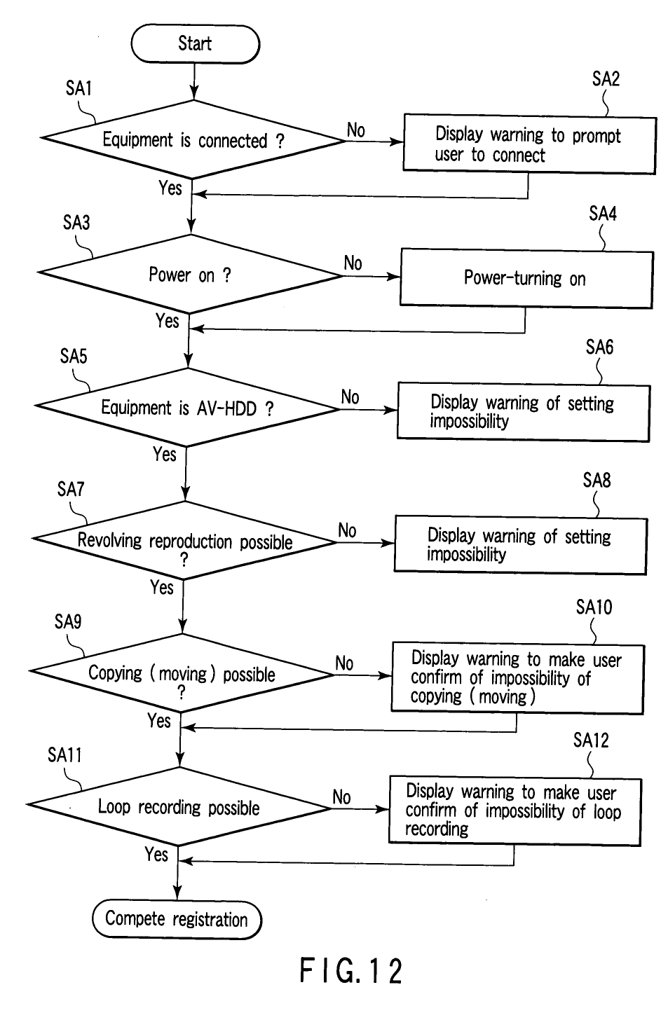

FIG. 12 shows the flowchart of an example of operations in the case that, for example, the user registers the HDD 41a as an expansion capacity for the internal recording equipment (AV-HDD 41). When registering the external equipment as internal equipment, the function checking unit 56gl selects the external equipment, for example, from the menu screen. On the menu screen, such an item of “registers external equipment as internal equipment” is appeared. When the user selects this item through the cursor key 17f and presses the determination key 17g, it is started to check the connected equipment and the list of the connected equipment (or a list of the connected equipment under the management by the registration unit 56g0) is displayed on the screen.

When an equipment selection is conducted from the list of the connected equipment, it is checked whether or not any equipment is connected to the receiver 11 and the checking result is displayed on the screen (block SA1). In general, in the case that the power of the previously used equipment has been tuned off, the area of the corresponding equipment among the equipment in the list is grayed out sometimes.

When any external equipment is not connected to the broadcast receiver 11, the video display 14 issues a warning to the user to prompt of connection of any equipment (block SA2). When any external equipment is connected to the broadcast receiver 11, the equipment management unit 56g checks whether or not the power for the connected equipment is turned on (block SA3), and if the power is turned off, the power is turned on (block SA4). When the power is turned on, the equipment management unit 56g checks whether or not the type of the connected equipment is an AV-HDD, namely, the same type as that of the AV-HDD 41 which is integrated with the broadcast receiver 11 (block SA5). If the connected equipment is not the same type as that of the AV-HDD 41, the video display 14 displays the warning of the fact that the connected equipment is impossible to be set and registered (block SA6).

In the foregoing block SA5, when it is determined that the external equipment is the same type as that of the AV-HDD 41, the checking unit 56g1 checks whether or not the type of the external equipment to be set has a revolving reproduction function (block SA7). In this system, since the AV-HDD 41, surely integrated with the broadcast receiver 11, has the revolving reproduction function, it is also needed for the AV-HDD 41a to be set to surely have the revolving reproduction function. If the AV-HDD 41a does not have the function of the revolving reproduction function, the video display unit 14 displays the warning that the external equipment is not allowed being set (block SA8).

The revolving reproduction function is one to sequentially chase the pre-recorded part to reproduce it by a reproduction operation even in the middle of, for example, recording of the reserved program.

When it is determined that the AV-HDD 41a can perform the revolving reproduction in the block SA7, it is checked whether or not the AV-HDD 41a has copying and moving functions (block SA9). If the AV-HDD 41a does not have copying and moving functions, the video display unit 14 displays the warning, indicating that the AV-HDD 41a can not copy and move (block SA10).

When it is determined that the AV-HDD 41a has the copying and moving functions, it is determined whether loop recording is possible or not. The loop recording is a function of cyclically recording under the setting of a fixed recording area. It is also possible to perform the revolving reproduction in this fixed recording area. If the external equipment has not the function of the loop recording function, the video display unit 14 displays the warning to make the user confirm that the loop recording reproduction is impossible. Otherwise stated, the equipment management unit 56g completes the registration of the external equipment (in this case, AV-HDD 41a). In the foregoing steps, when the user intend to confirm the functions of the equipment to be registered, the system performs authentication processing and confirmation processing between the main body of the television broadcast receiver and the external equipment via the i.Link. Accordingly, it is no wonder for the external recording equipment to have a reply function to reply equipment information on a status or the like when the reply is required.

In the case of this embodiment, although the additionally provided equipment is set, it is not necessary to make the loop recording function as an essential requirement.

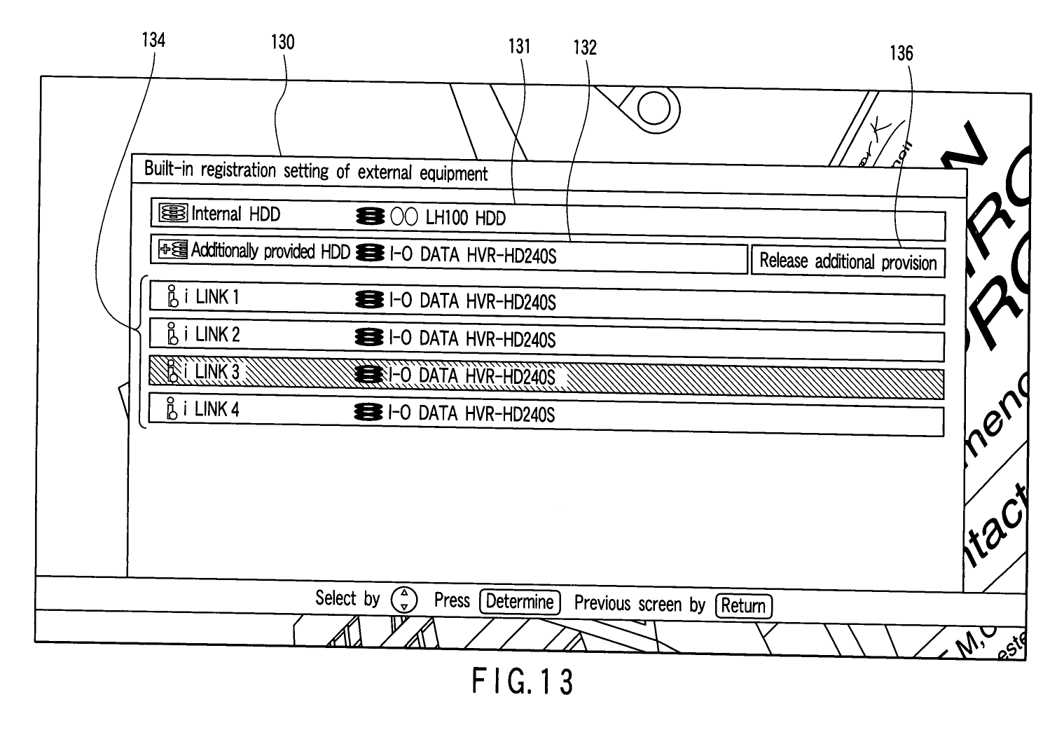

FIG. 13 shows the example of a screen, for example, when the AV-HDD 41a is additionally provided to be set and registered. A screen 130 with a title of “setting of external equipment as internal equipment” is appeared and the equipment name 131 of the HDD originally incorporated in the broadcast receiver 11 and the equipment name 132 of the additionally provided HDD are displayed on the screen 130. Furthermore, other equipment 134 connected to an i.Link terminal 24 is listed and displayed.

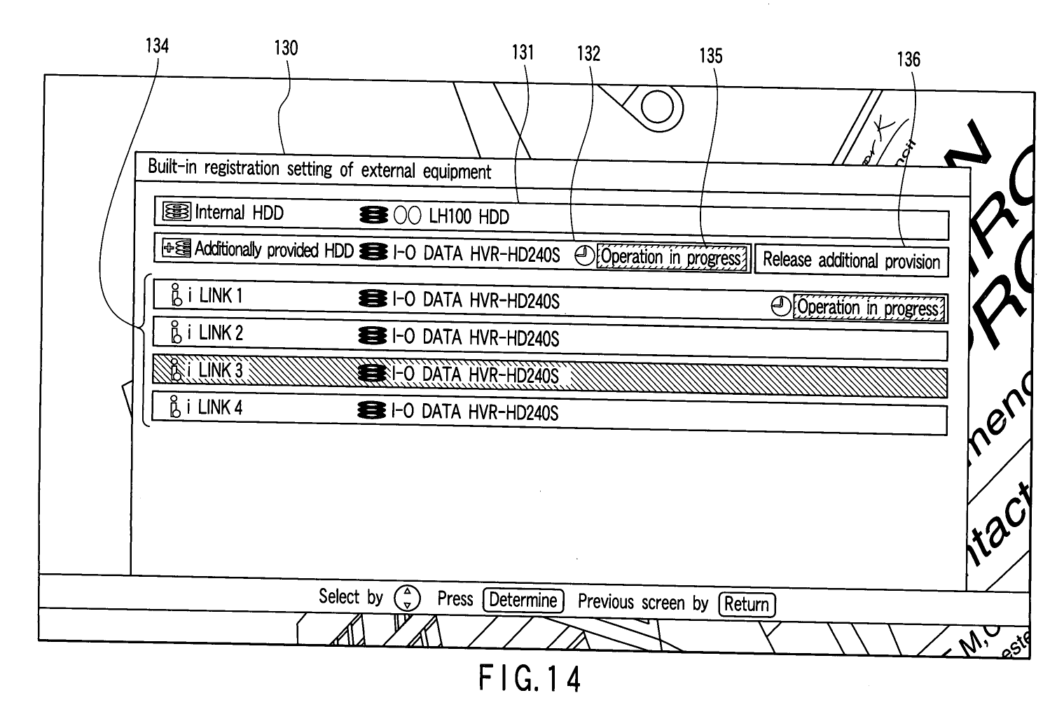

FIG. 14 shows the example of a screen in the case that an external equipment to be set is now in operation when the user intends to set and register the external equipment so that the external equipment becomes equivalent to the internal equipment as mentioned above. In this case, a mark 135 indicating that the external equipment to be set is in operation is appeared. Here, the external equipment cannot be set and registered, so that the user can release the adding by putting the “Cursor” at an “addition release” button 136 to operate the determination key 17g marked as “Determine”.

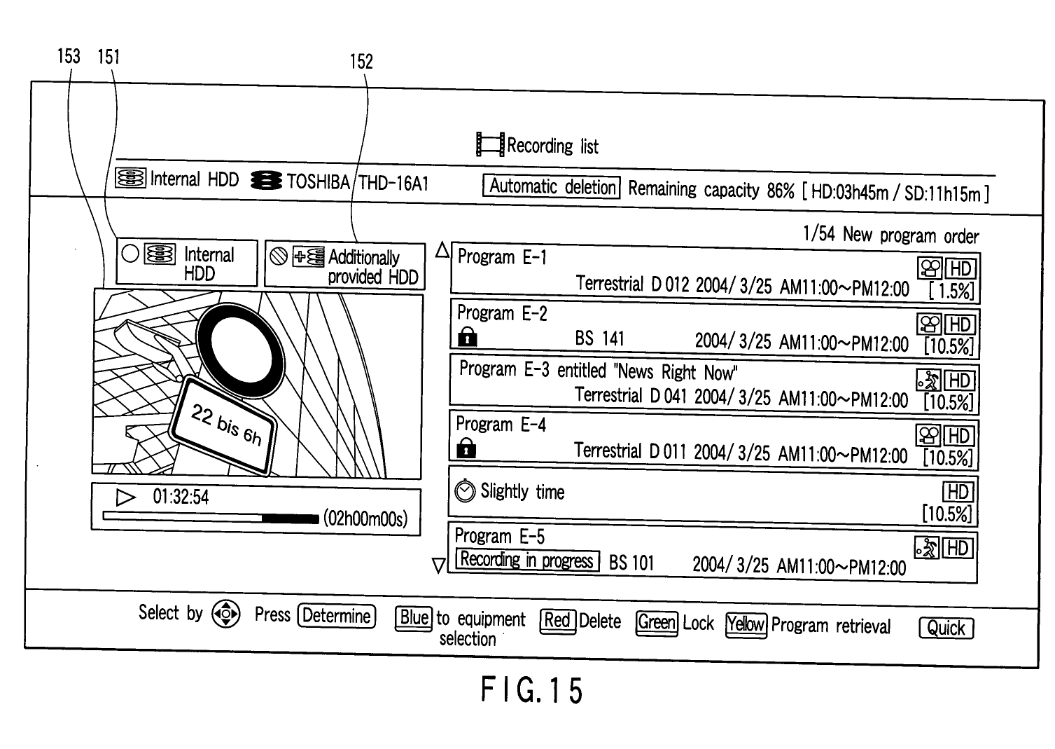

FIG. 15 shows the example of a display of a recording list (right side on screen) on a screen after the external equipment is additionally provided to the broadcast receiver 11. FIG. 15 also shows an aspect that the user pre-views, for example, a recorded program entitled “News eleven” at the left side of the screen. In this case, the screen displays the fact that the internal HDD and the additionally provided HDD are present in partial display areas 151 and 152, respectively. Discrimination marks of the display areas 151 and 152 may be different in color, so that it can be recognized that which HDD is now in reproduction of its preview video on a preview screen 153. Moreover, either mark of the display area 151 or 152 may blink on and off.

This broadcast receiver 11 has a function to automatically change over to perform recording for the external recording equipment when the remaining capacity of the internal recording equipment is decreased.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A television broadcast receiver, comprising a control unit to manage operations, a receiving unit to receive a broadcast signal, based on the control by the control unit, a demodulating and signal processing unit to demodulate and signal-process the received signal to covert it into a display signal, and a recording processor to record the display signal onto a recording medium in accordance with an operation input, the broadcast receiver further comprising:
a first recording equipment integrated with the broadcast receiver;
a connection terminal to connect external second recording equipment; and
an equipment management unit to register the second recording equipment as expansion equipment of a capacity of the first recording equipment.

2. The television broadcast receiver according to claim 1, wherein the equipment management unit comprises:
a function checking unit to check whether or not the second recording equipment has the same function as that of the first recording equipment in accordance with the operation input;
an additionally provided equipment registration unit to registering the second recording equipment if the second recording equipment and the first recording equipment are same in function in a checking result from the checking unit; and
an alarm processor to alarm if the second recording equipment and the first recording equipment are different in function in the checking result from the checking unit.

3. The television broadcast receiver according to claim 2, wherein the function checking unit determines that the second recording equipment is a hard disk device and has a revolving reproduction function.

4. The television broadcast receiver according to claim 2, wherein the function checking unit determines that the second recording equipment is a hard disk device, has a revolving reproduction function and has copying and moving functions.

5. A television broadcast receiving method, having first recording equipment integrated with a television broadcast receiver and a control unit to manage operations, receiving a broadcast signal on the basis of the control by the control unit, demodulating and signal-processing the received signal by a demodulating and signal processing unit to convert it into a display signal, and recording the display signal onto a recording medium by a recording processor, the receiving method further comprising:
checking whether or not external second recording equipment connected to a terminal for connecting external equipment is the same type as that of the first recording equipment;
checking whether or not the second recording equipment has a revolving reproduction function; and
registering the second recording equipment, as an additionally provided equipment, in a registration unit if the second recording equipment is the same type as that of the first recording equipment and has the revolving reproduction function.

6. The television broadcast receiving method according to claim 5, further comprising:
checking whether or not the second recording equipment has copying and moving functions; and
registering the second recording equipment, as an additionally provided equipment, into the registration unit if the second recording equipment is the same type as that of the first recording equipment, has a revolving reproduction function and has copying and moving functions.

7. The television broadcast receiving method according to claim 5, further comprising:
displaying a mark indicating that the additionally provided equipment is present in a part of an area on a screen when the second recording equipment is registered as the additionally provided equipment.

8. The television broadcast receiving method according to claim 5, further comprising:
displaying a list of connected equipment on a screen; and
displaying a comment that the second recording equipment is in operation onto the screen when the second recording equipment is selected as the additionally provided equipment and if the second recording equipment is in recording operation.

9. The television broadcast receiving method according to claim 5, further comprising:
obtaining an identification display indicating the fact that the second recording equipment is registered as an additionally provided equipment in a part of an area of a screen different from a display area of a list of the recording equipment.

10. The television broadcast receiving method according to claim 5, further comprising:
obtaining an identification display indicating that the second recording equipment is registered as the additionally provided equipment onto a part of a screen; and
displaying a release button to release the registration.

11. The television broadcast receiving method according to claim 5, further comprising:
automatically changing over to recording by the second recording equipment when the remaining capacity of the first recording equipment is reduced.

12. A television system, including a television receiver having first recording equipment integrated with a television broadcast receiver, a control unit to control operations, a receiving unit to receive a broadcast signal on the basis of the control by the control unit, demodulating and signal processing unit to demodulate and signal-process the received signal to convert it into a display signal, a recording processor to record the display signal onto a recording medium in accordance with an operation input, and external second recording equipment connected to the connection terminal, wherein
the second recording equipment has replying means for replying equipment information in accordance with an authentication request; and
the television receiver has means for registering the second recording equipment as the additionally provided equipment in a registration unit when it is confirmed that the second recording equipment is the same type as that of the first recording equipment, has a revolving reproduction function and has copying and moving functions by analyzing the equipment information.
